(19) United States
(12) Patent Application Publication
(10) Pub. No.: US 2025/0267412 A1
(43) Pub. Date: Aug. 21, 2025

(54) EAR-WEARABLE ELECTRONIC DEVICE INCLUDING FACEPLATE

(71) Applicant: Starkey Laboratories, Inc., Eden Prairie, MN (US)

(72) Inventors: Ganesh Borra, Minneapolis, MN (US); Ryan Owens, Hopkins, MN (US)

(21) Appl. No.: 19/055,231

(22) Filed: Feb. 17, 2025

Related U.S. Application Data
(60) Provisional application No. 63/555,206, filed on Feb. 19, 2024.

(51) Int. Cl. H04R 25/00; H04R 1/08

(52) U.S. Cl. CPC H04R 25/658; H04R 1/086; H04R 25/602; H04R 25/609; H04R 2225/025

(57) ABSTRACT

Various embodiments of an ear-wearable electronic device are disclosed. The device includes a faceplate having an outer surface and an inner surface, where the faceplate defines a cavity disposed in the inner surface of the faceplate; a microphone disposed at least partially within the cavity and including an inlet; and an acoustic path disposed within the faceplate and extending between a microphone port disposed at the outer surface of the faceplate and an outlet disposed in the cavity. The acoustic path is acoustically coupled to the inlet of the microphone via the outlet. The inlet of the microphone is disposed in the cavity or in the outlet of the acoustic path. The acoustic path is configured such that all acoustic waves propagating within the acoustic path pass directly from the acoustic path to the inlet of the microphone.

This application claims the benefit of U.S. Provisional Application No. 63/555,206, filed Feb. 19, 2024, the disclosure of which is incorporated by reference herein in its entirety.

### BACKGROUND

Ear-wearable electronic devices such as hearing devices are disposed in an ear of a wearer or inserted into an opening of an ear canal of the wearer and typically include a housing or shell with electronic components such as a receiver (i.e., speaker) disposed within the housing. The receiver is adapted to provide acoustic information in the form of acoustic waves to the wearer's ear canal from a controller either disposed within the housing of the hearing device or connected to the hearing device by a wired or wireless connection. This acoustic information can include music or speech from a recording or other source, e.g., ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

### SUMMARY

In general, the present disclosure provides various embodiments of an ear-wearable electronic device that includes an acoustic path disposed at least partially within a faceplate of the device. The acoustic path extends between a microphone port disposed at an outer surface of the faceplate and an outlet disposed in a cavity that is disposed in an inner surface of the faceplate. The acoustic path can be acoustically coupled to an inlet of a microphone that is disposed at least partially within the cavity. The acoustic path can direct acoustic waves that are incident upon the microphone port on the outer surface side of the faceplate to the inlet of the microphone. In one or more embodiments, the acoustic path is devoid of a manifold associated with the microphone, e.g., the microphone does not include a manifold that directs acoustic waves into the inlet of the microphone. Instead, all acoustic waves propagating within the acoustic path pass directly from the acoustic path to the inlet of the microphone.

In one aspect, the present disclosure provides an ear-wearable electronic device that includes a faceplate having an outer surface and an inner surface, where the faceplate defines a cavity disposed in the inner surface of the faceplate; a microphone disposed at least partially within the cavity and including an inlet; and an acoustic path disposed at least partially within the faceplate and extending between a microphone port disposed at the outer surface of the faceplate and an outlet disposed in the cavity. The acoustic path is acoustically coupled to the inlet of the microphone via the outlet. Further, the inlet of the microphone is disposed in the cavity or in the outlet of the acoustic path. The acoustic path is devoid of a manifold associated with the microphone.

In another aspect, the present disclosure provides an car-wearable electronic device including a faceplate having an outer surface and an inner surface, where the faceplate defines a cavity disposed in the inner surface of the faceplate; a microphone disposed at least partially within the cavity and including an inlet; and an acoustic path disposed within the faceplate and extending between a microphone port disposed at the outer surface of the faceplate and an outlet disposed in the cavity. The acoustic path is acoustically coupled to the inlet of the microphone via the outlet. The inlet of the microphone is disposed in the cavity or in the outlet of the acoustic path. The acoustic path is configured such that all acoustic waves propagating within the acoustic path pass directly from the acoustic path to the inlet of the microphone.

In another aspect, the present disclosure provides a method of forming an car-wearable electronic device including disposing a cavity in an inner surface of a faceplate; disposing a microphone at least partially within the cavity; and disposing an acoustic path at least partially within the faceplate. The acoustic path extends between a microphone port disposed at an outer surface of the faceplate and an outlet disposed in the cavity. Further, the acoustic path is acoustically coupled to the inlet of the microphone via the outlet. The inlet of the microphone is disposed in the cavity or in the outlet of the acoustic path. The method further includes directing acoustic waves through the microphone port and the acoustic path to the inlet of the microphone. The acoustic path is configured such that all acoustic waves propagating within the acoustic path pass directly from the acoustic path to the inlet of the microphone.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device.

FIG. 2 is a schematic side view of the ear-wearable electronic device of FIG. 1.

FIG. 3 is a schematic exploded view of the ear-wearable electronic device of FIG. 1.

FIG. 4 is another schematic exploded view of the ear-wearable electronic device of FIG. 1.

FIG. 5 is a schematic cross-section view of a portion of the ear-wearable electronic device of FIG. 1 with a shell of the device removed for clarity.

FIG. 6 is a schematic cross-section view of a portion of a faceplate of the ear-wearable electronic device of FIG. 1.

FIG. 7 is a schematic cross-section view of a portion of the ear-wearable electronic device of FIG. 1.

FIG. 8 is a schematic side view of a portion of an inner surface of the faceplate of FIG. 1.

FIG. 9 is a schematic plan view of the faceplate of the ear-wearable electronic device of FIG. 1.

FIG. 10 is a flowchart of a method of forming the ear-wearable electronic device of FIG. 1.

FIG. 11 is a schematic diagram of another embodiment of an ear-wearable electronic device.

### DETAILED DESCRIPTION

In general, the present disclosure provides various embodiments of an ear-wearable electronic device that includes an acoustic path disposed at least partially within a faceplate of the device. The acoustic path extends between a microphone port disposed at an outer surface of the faceplate and an outlet disposed in a cavity that is disposed in an inner surface of the faceplate. The acoustic path can be acoustically coupled to an inlet of a microphone that is disposed at least partially within the cavity. The acoustic path can direct acoustic waves that are incident upon the microphone port on the outer surface side of the faceplate to the inlet of the microphone. In one or more embodiments, the acoustic path is devoid of a manifold associated with the microphone, e.g., the microphone does not include a manifold that directs acoustic waves into the inlet of the microphone. Instead, all acoustic waves propagating within the acoustic path pass directly from the acoustic path to the inlet of the microphone.

Some currently-available ear-wearable electronic devices include a microphone having a manifold that is connected to a housing of the microphone. The manifold forms a portion of an acoustic path that extends from a microphone port at an outer surface of a faceplate of the device to an outlet of the acoustic path that is acoustically coupled to an inlet of the microphone. The manifold is configured to direct acoustic waves that have propagated through the acoustic path into the microphone housing, where such acoustic waves can be converted to one or more electrical signals by the microphone. Such manifold is custom-tooled and installed on top of the microphone inlet to route the acoustic path from the smaller microphone port to the relatively larger inlet of the microphone. Integrating this manifold into the faceplate can create plastic injection molding tooling challenges. Further, the manifold and its integration into the acoustic path of the faceplate can also cause variability in acoustic performance between completed faceplates.

One or more embodiments of car-wearable electronic devices described herein can provide various advantages over currently-available devices. For example, the microphone manifold can be eliminated from the acoustic path, thereby simplifying acoustic coupling of the microphone to the acoustic path of the faceplate. In one or more embodiments, the microphone manifold can be eliminated by integrating the manifold into the design of the acoustic path. This integration of the manifold can reduce an overall size of the device by reducing a length and width of the faceplate. Further, elimination or integration of the manifold can also reduce the risk of inconsistent acoustic paths from device to device and enable more customized acoustic paths for optimal performance, which is difficult to achieve when integration of a microphone manifold into the acoustic path is required.

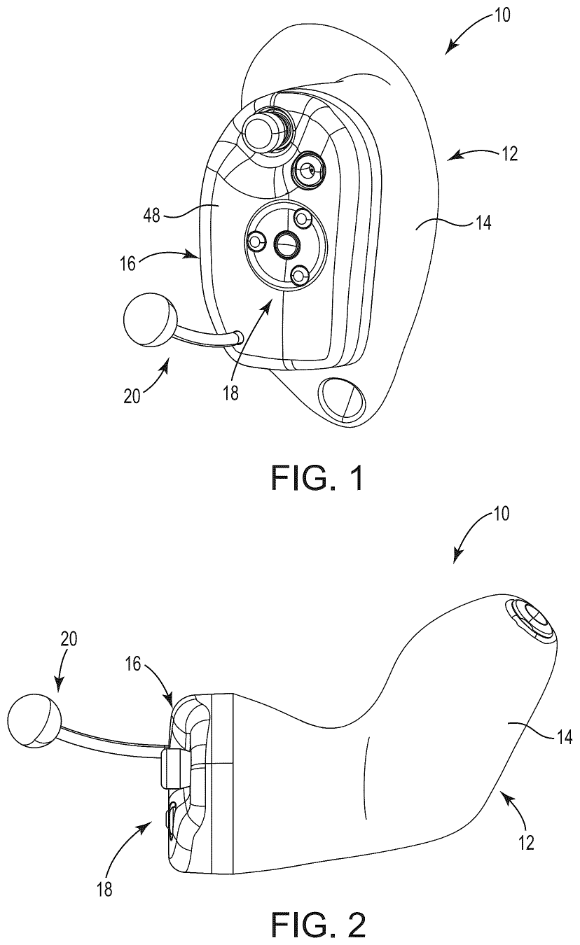

FIGS. 1-4 are various views of one embodiment of an ear-wearable electronic device 10. The device 10 can represent a variety of different custom hearing devices and can be configured as an in-the-car (ITE), in-the-canal (ITC), completely-in-canal (CIC) or invisible-in-canal (IIC) type hearing device, for example. The device 10 includes a shell 12, which, in one or more embodiments, can have a uniquely shaped outer surface 14 that corresponds uniquely to an car geometry of a wearer of the device. For example, the shell 12 can be developed based on a mold taken from the wearer's ear. As such, the device 10 can be considered a custom ear-wearable electronic device. The shell 12 is configured to be disposed at least partially within an car canal of the wearer.

The device 10 also includes a faceplate 16, which is shown connected to the shell 12 in FIGS. 1 and 2. The faceplate 16 can include a number of features, such as charge contacts 18 and a removal handle 20. The charge contacts 18 are configured to engage charge contacts of a charging unit when charging a battery 22 of the device 10. The faceplate 16 can be connected to the shell 12 using any suitable technique, e.g., adhering, mechanically fastening, friction or press fitting, bonding, welding, etc.

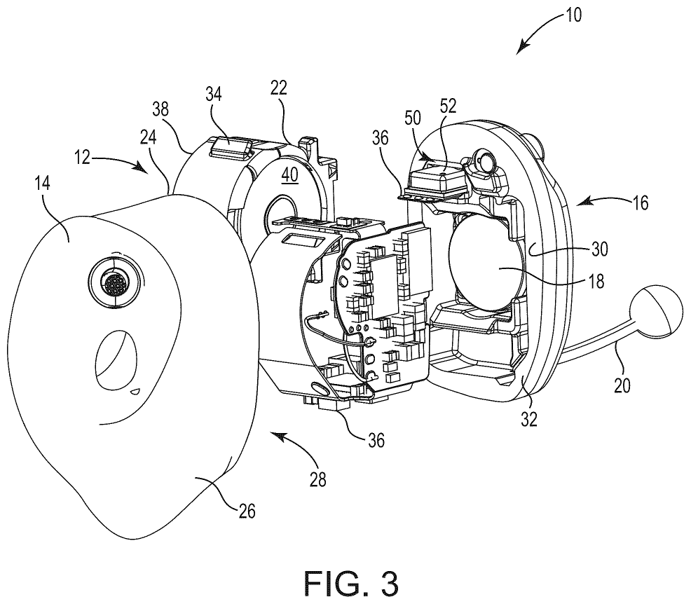

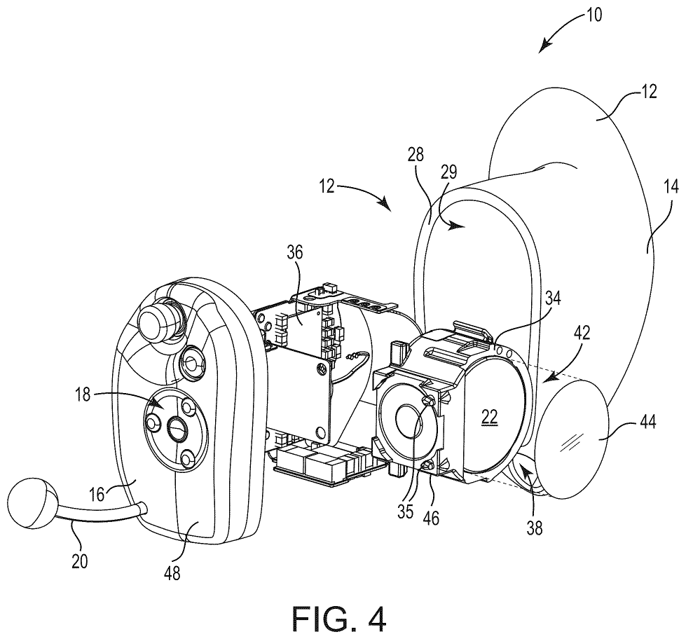

With reference to FIGS. 3-4, the shell 12 includes an end surface 24 having a predefined configuration that can be standardized across a family or families of devices 10. The shell 12 includes a shell body 26, a void 28 within the shell body, and an opening 29 to the void. The end surface 24 defines a substantially flat portion of the shell 12 disposed along the portion of the shell body 26 that forms the opening 29 to the void 28.

The faceplate 16 has an inner surface 30 that includes a mating surface 32 having a predefined configuration that can be standardized across the same family or families of the devices 10. The mating surface 32 extends along a periphery of the inner surface 30 of the faceplate 16 and has a generally flat shape. More particularly, the mating surface 32 of the faceplate 16 has a shape and size configured to matingly engage the end surface 24 of the shell 12. Standardization of the end surface 24 of the shell 12 and the mating surface 32 of the faceplate 16 can significantly reduce the manufacturing complexity and cost of fabricating a custom car-wearable electronic device, while providing for a custom-shaped shell unique to the car geometry of a particular wearer of the device 10.

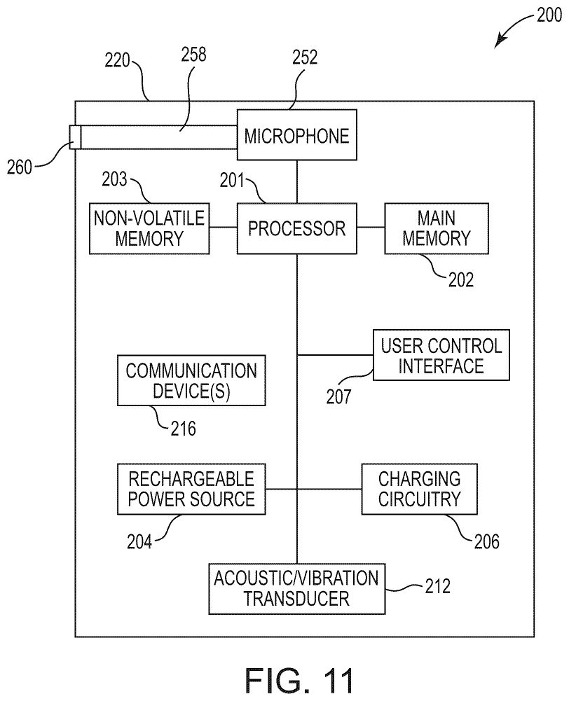

FIGS. 3 and 4 illustrate other components of the device 10, including a battery housing 34 and a flexible printed circuit board assembly (PCBA) 36. In general, the device 10 can include any suitable electronic circuitry and components disposed on or within the device, e.g., one or more of the electronic circuitry and components described herein regarding car-wearable electronic device 200 of FIG. 11. The battery housing 34 includes a battery compartment 38 is configured to receive the battery 22, such as a lithium-ion rechargeable battery. As shown, the battery compartment 38 and the battery housing 34 have a shape that conforms to the shape of the battery 22. More particularly, the battery 22, battery housing 34, and battery compartment 38 are shown to have a generally cylindrical shape. It is noted that, in some implementations, the battery 22 can have a polygonal shape (e.g., rectangle, square), and that the battery housing 34 and battery compartment 38 can conform to the shape of the polygonal battery; however, a cylindrical battery, battery housing, and battery compartment may be preferred for enhancing packaging efficiency. The battery housing 34 and battery compartment 38 can include any suitable material, e.g., a polymeric material. Further, the battery housing 34 can include a mounting interface 35 (FIG. 4) that is configured to be connected to the inner surface 30 of the faceplate 16 using any suitable technique, e.g., one or more of the techniques described in in U.S. Patent Publication No. 2023/0336928 A1, entitled COMPACT ELECTRO-MECHANICAL PACKAGING FOR A CUSTOM HEARING DEVICE.

The battery compartment 38 includes a closed end 40 and an opposing open end 42. The open end 42 is dimensioned to receive the battery 22. The open end 42 can be configured to receive a cap 44 that is configured to seal the battery 22 within the battery compartment 38 for purposes of safety. The cap 44 can be snapped into place to seal the battery 22 within the battery compartment 38.

In one or more embodiments, the battery compartment 38 has a short dimension and a long dimension depending on the shape of the battery 22. In such embodiments, the faceplate 16, which can have a generally flat and curved exterior surface, can be oriented orthogonal to the long dimension of the battery compartment 38. For example, the battery 22 can have a cylindrical shape with two opposing flat sides. The battery compartment 38 can be configured such that the flat sides of the battery 22 are oriented orthogonal to the exterior surface of the faceplate 16. This orientation of the battery 22 relative to the faceplate 16 provides for a tighter and smaller packaging fit for the battery and battery housing 34.

The battery housing 34 includes an exterior surface 46 that can support the flexible PCBA 36. In one or more embodiments, the PCBA 36 can be supported by the faceplate 16. In one or more embodiments, the PCBA 36 can be supported by one or both of the exterior surface 46 of the battery housing 34 and the faceplate 16. It is understood that the flexible PCBA 36 is a laminated, flexible sandwich structure that can include conductive layers, insulating layers, and vias allowing for interconnections between layers. The PCBA 36 can support and/or be coupled to various electronic components (e.g., integrated circuits, processors, memories), electrical circuitry (passive and active electrical components), one or more sensors, and/or one or more transducers (e.g., a microphone, a receiver, etc.).

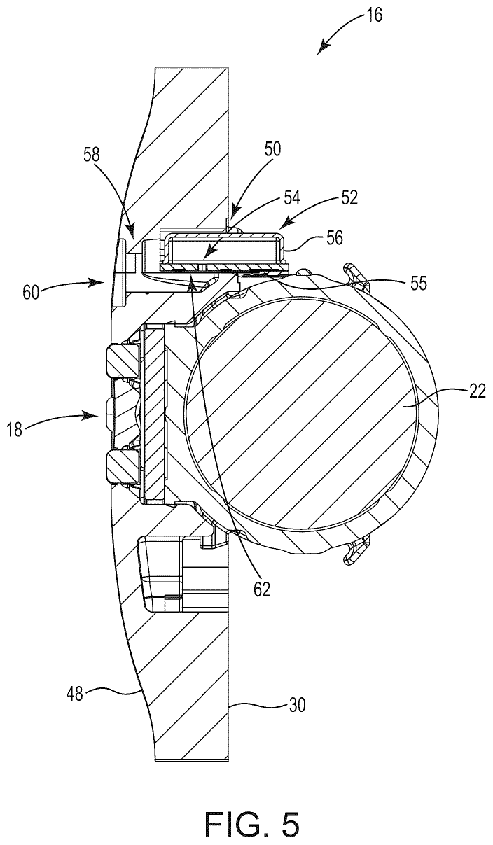

Connected to the shell 12 of the device 10 is the faceplate 16. The faceplate 16 includes an outer surface 48 and the inner surface 30. As shown in FIG. 5, the faceplate 16 defines a cavity or pocket 50 disposed in the inner surface 30 of the faceplate. Disposed at least partially within the cavity 50 is a microphone 52. The microphone 52 includes an inlet 54. In one or more embodiments, the inlet 54 can be disposed in an outer major surface 55 of a housing 56 of the microphone 52. The microphone 52 further includes an outer major surface 55 within which the inlet 54 can be disposed. In one or more embodiments, the outer major surface 55 of the microphone 52 can partially occlude the outlet 62 of the acoustic path 58 as is further described herein.

The device 10 also includes the acoustic path 58 disposed at least partially within the faceplate 16 and extending between a microphone port 60 disposed at the outer surface 48 of the faceplate and an outlet 62 disposed in the cavity 50 of the faceplate. The acoustic path 58 is acoustically coupled to the inlet 54 of the microphone 52 via the outlet 62. As used herein, the term “acoustically coupled” means fluidically coupled or that any barrier positioned between two or more elements or components that are acoustically coupled is generally acoustically transparent for frequencies of interest, where acoustically transparent means that the element or component attenuates sound at a sound pressure level of no greater than 6 dB. In one or more embodiments, the inlet 54 can be disposed in the cavity 50. In one or more embodiments, the inlet 54 can be disposed in the outlet 62 of the acoustic path 58. In one or more embodiments, the acoustic path 58 is devoid of a manifold associated with the microphone 52 as is further described herein. Further, in one or more embodiments, the acoustic path 58 is configured such that all acoustic waves propagating within the acoustic path pass directly from the acoustic path to the inlet 54 of the microphone 52 (with the exception of any acoustic energy of the propagating acoustic waves that may be absorbed by walls of the acoustic path or redirected or reflected back through the outlet 62).

The faceplate 16 can take any suitable shape and have any suitable dimensions. Further, the faceplate 16 can include any suitable materials, e.g., at least one of an inorganic (e.g., metallic, ceramic) or polymeric material. In one or more embodiments, the faceplate 16 includes a nylon-based polyamide thermoplastic material. The faceplate 16 can be manufactured using any suitable technique, e.g., molding, injection molding, 3D printing, etc.

Defined by the faceplate 16 is the cavity 50, which can be disposed in the inner surface 30 of the faceplate using any suitable technique, e.g., etching, molding, etc. The cavity 50 can take any suitable shape and have any suitable dimensions. In one or more embodiments, the cavity 50 is configured to receive at least a portion of the microphone 52.

Any suitable portion or portions of the microphone 52 can be disposed within the cavity 50. In one or more embodiments, the microphone 52 is disposed completely or entirely within the cavity 50. The microphone 52 can include any suitable microphone, e.g., a MEMS microphone, an electret condenser microphone, co-joined microphone sets, etc. Although depicted as including one microphone 52, the device 10 can include any suitable number of microphones disposed in any suitable location on the device or disposed within the device. The microphone 52 can be electrically connected to the PCBA 36 using any suitable technique, e.g., one or more of the techniques described in U.S. Patent Publication No. 2023/0336928 A1. In one or more embodiments, the microphone 52 is configured to convert acoustic waves that are directed into the microphone housing 56 through the inlet 54 of the microphone by the acoustic path 58 into one or more electrical signals. In one or more embodiments, the microphone 52 does not include a manifold that would, in currently-available products, form a portion of the acoustic path 58 but would be separate from the acoustic path. Instead, the acoustic path 58 solely directs acoustic waves to the microphone 52 (or provides a pathway for acoustic waves to the microphone) without the assistance of a microphone manifold.

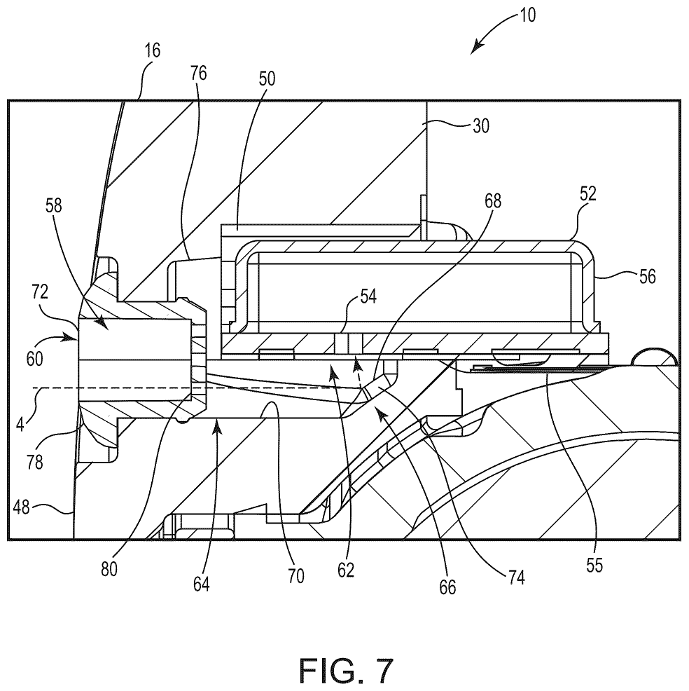

The microphone 52 includes the housing 56 that can take any suitable shape and have any suitable dimensions. The housing 56 includes the outer major surface 55 that can be disposed on a surface or surfaces of the cavity. The inlet 54 of the microphone 52 is disposed in any suitable portion of the outer major surface 55. In one or more embodiments, the outer major surface 55 can at least partially occlude the outlet 62 of the acoustic path 58. For example, as shown in FIG. 7, the outer major surface 55 of the microphone 52 can occlude at least a portion of the outlet 62 of the acoustic path 58 such that acoustic waves are directed from the outlet into the inlet 54 of the microphone. Any suitable portion of the outlet 62 can be occluded by the outer major surface 55. Further, as is also shown in FIG. 7, the inlet 54 can be disposed in the outlet 62 of the acoustic path 58 or adjacent to the outlet.

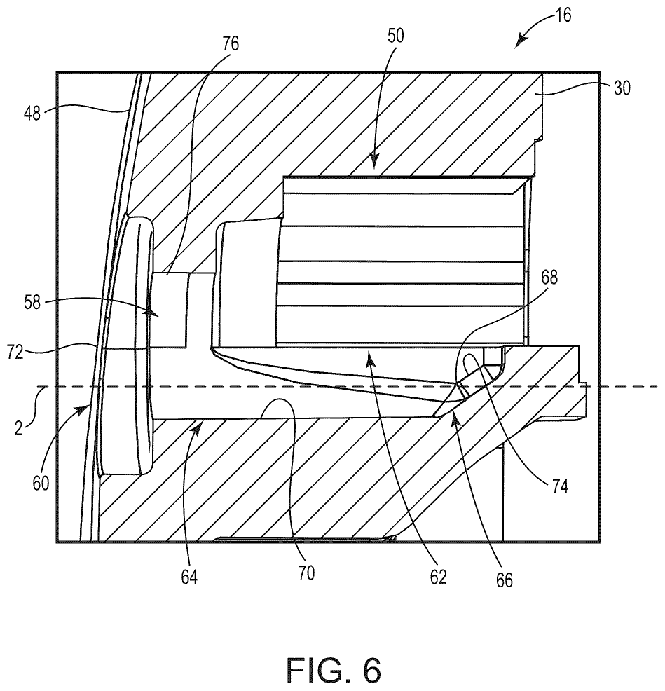

The acoustic path 58 is disposed at least partially within the faceplate 16. In one or more embodiments, the acoustic path 58 can be disposed completely or entirely within the faceplate 16. As shown in FIGS. 6-8, which are various schematic views of a portion of the faceplate 16, where the microphone 52 is removed from FIG. 6 for clarity, the acoustic path 58 extends between the microphone port 60 disposed at the outer surface 48 of the faceplate 16 and the outlet 62 disposed in the cavity 50. The acoustic path 58 can take any suitable shape and have any suitable dimensions. In one or more embodiments, the acoustic path 58 has a cross-sectional area in a plane substantially orthogonal to an acoustic axis 2 that decreases in a direction from the microphone port 60 to the outlet 62 of the acoustic path, where the acoustic path extends along the acoustic axis as shown in FIG. 6. In one or more embodiments, the acoustic path 58 has a constant cross-sectional area in the substantially orthogonal plane. Further, in one or more embodiments, the acoustic path 58 has a cross-sectional area in the substantially orthogonal plane that increases in the direction from the microphone port 60 to the outlet 62.

As mentioned herein, the acoustic path 58 can take any suitable shape. In one or more embodiments, one or more portions of the acoustic path 58 can take an elliptical shape in the orthogonal plane. In one or more embodiments, the acoustic path 58 can include a straight portion 64 adjacent to the microphone port 60 and a curved or faceted portion 66 adjacent to the outlet 62 of the acoustic path. As shown in FIG. 6, the second portion 66 has one or more facets 68 they can take any suitable shape and have any suitable dimensions. In one or more embodiments, the facets 68 of the second portion 66 can be configured to direct acoustic waves 4 that are propagating in the acoustic path 58 to the inlet 54 of the microphone 52 (FIG. 7).

The acoustic path 58 can be defined by the faceplate 16. For example, the acoustic path 58 can be formed by disposing a channel in the faceplate 16 that extends from the microphone port 60 to the outlet 62. In such embodiments, an inner surface 70 of the acoustic path 58 is formed by the material of the faceplate 16 and does not include any additional elements or components disposed in the acoustic path such as a microphone manifold. In one or more embodiments, the acoustic path 58 can be manufactured separately from the faceplate 16 and inserted into an opening in the faceplate using any suitable technique.

The microphone port 60 disposed at the outer surface 48 of the faceplate 16 can take any suitable shape and have any suitable dimensions. In one or more embodiments, the microphone port 60 can take an elliptical shape in a plane of the outer surface 48 of the faceplate 16.

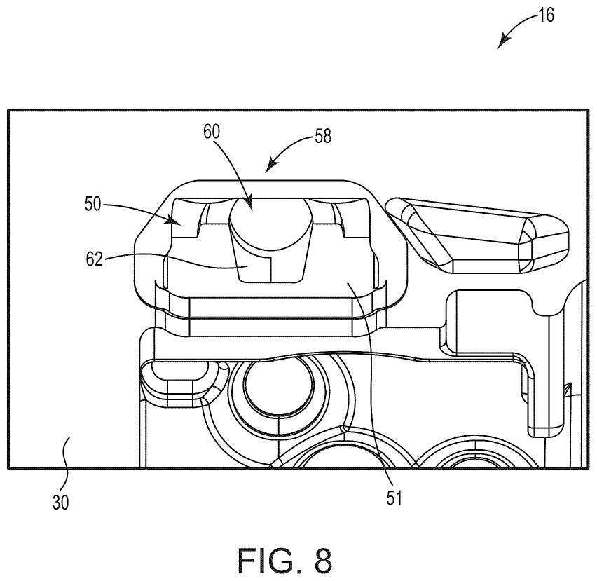

Further, the outlet 62 of the acoustic path 58 can take any suitable shape and have any suitable dimensions. As shown in FIG. 8, which is a schematic plan view of a portion of the inner surface 30 of the faceplate 16 with the microphone 52 removed for clarity, the outlet 62 can take an elongated shape that is disposed in an inner surface 51 of the cavity 50 and the inner surface 70 of the acoustic path 58 such that the acoustic path 58 is acoustically connected to the cavity 50 via the outlet.

The outlet 62 can be disposed in any suitable portion or portions of the acoustic path 58. As shown in FIG. 7, the acoustic path 58 can extend between a first end 72 and a second end 74, where the first end is defined by the microphone port 60 and the second end 74 can be disposed within the faceplate 16. In one or more embodiments, the outlet 62 of the acoustic path 58 can be disposed at the second end 74 of the acoustic path. Further, in one or more embodiments, the outlet 62 can be disposed along the acoustic path 58 between its first end 72 and second end 74.

As mentioned herein, the acoustic path 58 can take any suitable shape. In one or more embodiments, the acoustic path 58 can take a shape such that it includes a trap 76 as shown in FIG. 6 that is disposed in the faceplate 16 adjacent to the microphone port 60. The trap 76 can be configured to collect debris entering the acoustic path 58 through the microphone port 60. The trap 76 can take any suitable shape and have any suitable dimensions.

Although not shown, the device 10 can also include one or more acoustic filters that are acoustically coupled to the acoustic path 58. The device 10 can include any suitable acoustic filter, e.g., one or more embodiments of acoustic filters described in co-filed U.S. Patent Application Ser. No. 63,555,212, filed Feb. 19, 2024, and entitled EAR-WEARABLE ELECTRONIC DEVICE INCLUDING ACOUSTIC FILTER. One or more acoustic filters can be configured to reduce an intensity of acoustic waves sensed by the microphone 52 in a first frequency range (e.g., ultrasonic frequency range). Ear-wearable electronic devices such as hearing devices can include an acoustic path that can undesirably have a natural quarter-wavelength resonance at ultrasonic frequencies of between about 25 kHz and about 40 kHz. This resonance can amplify the sensitivity of a microphone of the device that may sometimes interfere with a sampling frequency of a digital signal processing (DSP) circuit of the device. Such interference can produce an audible “crackling” artifact in acoustic waves that are directed to a wearer by a receiver or speaker of the device. As a result, it may be preferred to remove or reduce these ultrasonic resonances in the acoustic waves provided to the wearer.

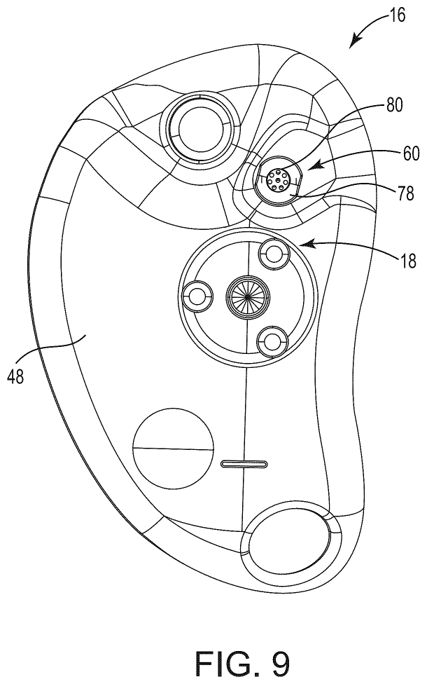

In one or more embodiments, the device 10 can also include a basket or filter 78 disposed at least partially within the microphone port 60 as shown in FIGS. 7 and 9. The basket 78 can be configured to collect debris entering the acoustic path 58 through microphone port 60. The basket 78 can take any suitable shape and have any suitable dimensions. In one or more embodiments, the basket 78 can include one or more openings 80 configured to transmit acoustic waves that enter the microphone port 60 into the acoustic path 58.

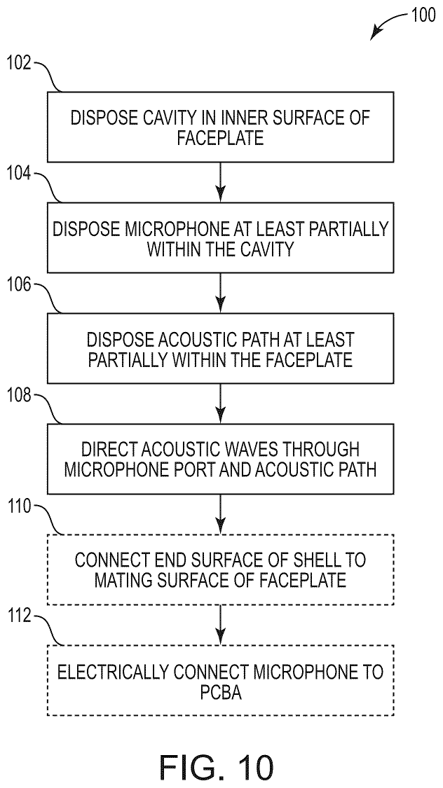

The various embodiments of car-wearable electronic devices described herein can be manufactured using any suitable technique. For example, FIG. 10 is a flowchart of one embodiment of a method 100 of forming the car-wearable electronic device 10. Although described regarding car-wearable electronic device 10 of FIGS. 1-9, the method 100 can be utilized to form any suitable car-wearable electronic device. At 102, the cavity 50 can be disposed in the inner surface 30 of the faceplate 16 using any suitable technique, e.g., molding, etching, ablation, laser drilling, etc. For example, in one or more embodiments, the cavity 50 can be disposed in the inner surface 30 of the faceplate 16 by molding the faceplate. In one or more embodiments, the cavity 50 can be disposed by etching the cavity into the inner surface 30 of the faceplate 16 using any suitable etching technique. Further, the cavity 50 can be disposed by 3D printing the faceplate 16 such that cavity is formed during the 3D printing process.

The microphone 52 can be disposed at least partially within the cavity 50 at 104 using any suitable technique. At 106, the acoustic path 58 can be disposed at least partially within the faceplate 16 using any suitable technique, e.g., molding, etching, drilling, laser drilling, etc. In one or more embodiments, the acoustic path 58 can be disposed at least partially within the faceplate 16 by molding the faceplate such that the acoustic path is formed during the molding process. Further, in one or more embodiments, the acoustic path 58 can be disposed at least partially within the faceplate 16 by etching the acoustic path into the outer surface 48 of the faceplate such that extends from the microphone port 60 at the outer surface of the faceplate to the outlet 62 in the cavity 50 using any suitable etching technique. Further, in one or more embodiments, the acoustic path 58 can be disposed at least partially within the faceplate 16 by 3D printing the faceplate to form the acoustic path.

The acoustic path 58 extends between the microphone port 60 disposed at the outer surface 48 of the faceplate and the outlet 62 disposed in the cavity 50. The acoustic path 58 is acoustically coupled to the inlet 54 of the microphone 52 via the outlet 62 of the acoustic path 58. Further, the inlet 54 of the microphone 52 is disposed in the cavity 50 or in the outlet 62 of the acoustic path 58. At 108, acoustic waves can be directed through the microphone port 60 and the acoustic path 58 to the inlet 54 of the microphone 52 using any suitable technique (e.g., diffraction). In one or more embodiments, the acoustic path 58 is configured such that all acoustic waves propagating within the acoustic path pass directly from the acoustic path to the inlet 54 of the microphone 52.

At 110, the end surface 24 of the shell 12 can optionally be connected to the mating surface 32 of the faceplate 16 using any suitable technique. Further, at 112, the microphone 52 can be electrically connected to the PCBA 36 that is disposed adjacent to the inner surface 30 of the faceplate 16 using any suitable technique.

The various embodiments of car-wearable devices described herein can include any suitable electronic components or circuitry. For example, FIG. 11 is a block diagram that illustrates one embodiment of a system and car-wearable electronic device 200 in accordance with any of the embodiments disclosed herein. The device 200 includes a housing 220 configured to be worn in, on, or about an car of a wearer. The device 200 shown in FIG. 11 can represent a single device configured for monaural or single-car operation or one of a pair of hearing devices configured for binaural or dual-car operation. Various components are situated or supported within or on the housing 220. The housing 220 can be configured for deployment on a wearer's ear (e.g., a behind-the-car device housing), within an ear canal of the wearer's ear (e.g., an in-the-car, in-the-canal, invisible-in-canal, or completely-in-the-canal device housing) or both on and in a wearer's ear (e.g., a receiver-in-canal or receiver-in-the-car device housing).

The device 200 includes a processor 201 operatively coupled to a main memory 202 and a non-volatile memory 203. The processor 201 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 201 can include or be operatively coupled to main memory 202, such as RAM (e.g., DRAM, SRAM). The processor 201 can include or be operatively coupled to non-volatile (persistent) memory 203, such as ROM, EPROM, EEPROM or flash memory.

The device 200 includes an audio processing facility operably coupled to, or incorporating, the processor 201. The audio processing facility includes audio signal processing circuitry (e.g., analog front-end, analog-to-digital converter, digital-to-analog converter, DSP, and various analog and digital filters), a microphone arrangement 252, and an acoustic/vibration transducer 212 (e.g., loudspeaker, receiver, bone conduction transducer, motor actuator). The acoustic transducer 212 produces amplified sound inside of the car canal. The microphone arrangement 252 can include one or more discrete microphones or a microphone array(s) (e.g., configured for microphone array beamforming). Each of the microphones of the microphone arrangement 252 can be situated at different locations of the housing 220. It is understood that the term microphone used herein can refer to a single microphone or multiple microphones unless specified otherwise. The microphone 252 is operatively coupled to the processor 201 and is configured to direct a microphone signal to the processor, which in turn directs a receiver signal to the transducer 212 that is based at least in part on the microphone signal.

At least one of the microphones 252 may be configured as a reference microphone producing a reference signal in response to external sound outside an ear canal of a user. Generally, at least one of the reference microphones 252 (also referred to as an externally facing microphones) is acoustically coupled to ambient air outside the housing 220 via an acoustic pathway or acoustic path 258 and a microphone port 260. The microphone port 260 allows air to pass between two parts of the housing 220 or may be formed within one part of the housing.

The device 200 may also include a user control interface 207 operatively coupled to the processor 201. The user control interface 207 is configured to receive an input from the wearer of the device 200. The input from the wearer can be any type of user input, such as a touch input, a gesture input, or a voice input. The user control interface 207 may be configured to receive an input from the wearer of the device 200.

The device 200 can include one or more communication devices 216. For example, the one or more communication devices 216 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 200 can include a near-field magnetic induction (NFMI) sensor (e.g., an NFMI transceiver coupled to a magnetic antenna) for effecting short-range communications (e.g., car-to-car communications, car-to-kiosk communications). The communications device 216 may also include wired communications, e.g., universal serial bus (USB) and the like.

The device 200 also includes a power source, which can be a conventional battery, a rechargeable battery (e.g., a lithium-ion battery), or a power source including a supercapacitor. In the embodiment shown in FIG. 11, the device 200 includes a rechargeable power source 204 that is operably coupled to power management circuitry for supplying power to various components of the device 200. The rechargeable power source 204 is coupled to charging circuity 206. The charging circuitry 206 is, for example, electrically coupled to charging contacts on the housing 220 that are configured to electrically couple to corresponding charging contacts of a charging unit when the device 200 is placed in the charging unit.

It is understood that various embodiments described herein may be implemented with any custom car-wearable electronic device without departing from the scope of this disclosure. The devices depicted in the figures are intended to demonstrate the subject matter, but not in a limited, exhaustive, or exclusive sense. Ear-wearable electronic devices, such as hearables (e.g., personal amplification devices, earbuds), hearing aids, and hearing assistance devices, include a custom shell within which internal components are disposed. Typical components of an car-wearable electronic device can include a digital signal processor (DSP), a controller, other digital logic circuitry (e.g., ASICs, FPGAs), memory (e.g., ROM, RAM, SDRAM, NVRAM, EEPROM, and FLASH), power management circuitry (e.g., including charging circuitry), one or more communication devices (e.g., an RF radio, a near-field magnetic induction (NFMI) device), one or more antennas, one or more microphones, audio processing circuitry, and an acoustic transducer (e.g., receiver/speaker), for example. Some car-wearable electronic devices can incorporate a long-range communication device, such as a Bluetooth® transceiver or other type of radio frequency (RF) transceiver. A communication device (e.g., a radio or NFMI device) of an car-wearable electronic device can be configured to facilitate communication between a left car device and a right car device. These and other components can be supported by, or coupled to, the flexible PCBA of the device as previously discussed.

Some car-wearable electronic devices can incorporate one or more sensors in addition to an IMU. For example, an car-wearable electronic device can incorporate one or more of a temperature sensor, an optical PPG sensor (e.g., pulse oximeter), a physiologic electrode-based sensor (e.g., ECG, oxygen saturation (SpO2), respiration, EMG, EEG, EOG, galvanic skin response, electrodermal activity sensor), and a biochemical sensor (e.g., glucose concentration, PH value, Ca+ concentration, hydration). Embodiments disclosed herein can incorporate one or more of the sensors disclosed in commonly-owned co-pending U.S. Patent Publication No. 2024/0007777 A1, entitled PHYSIOLOGIC SENSING PLATFORM FOR COOPERATIVE USE WITH AN EAR-WEARABLE ELECTRONIC DEVICE, and U.S. Patent Publication No. 2022/0190188 A1, entitled ELECTRO-OPTICAL PHYSIOLOGIC SENSOR.

The term car-wearable electronic device of the present disclosure refers to a wide variety of car-wearable electronic devices that can aid a person with impaired hearing. The term car-wearable electronic device also refers to a wide variety of devices that can produce optimized, amplified or processed sound for persons with normal hearing. Ear-wearable electronic devices of the present disclosure include hearables (e.g., earbuds) and hearing aids (e.g., hearing instruments), for example. As previously discussed, car-wearable electronic devices include, but are not limited to, ITE, ITC, CIC or IIC type hearing devices.

Embodiments of the disclosure are defined in the claims; however, herein there is provided a non-exhaustive listing of non-limiting examples. Any one or more of the features of these examples may be combined with any one or more features of another example, embodiment, or aspect described herein.

### Example Ex1

An ear-wearable electronic device that includes a faceplate having an outer surface and an inner surface, where the faceplate defines a cavity disposed in the inner surface of the faceplate; a microphone disposed at least partially within the cavity and including an inlet; and an acoustic path disposed at least partially within the faceplate and extending between a microphone port disposed at the outer surface of the faceplate and an outlet disposed in the cavity. The acoustic path is acoustically coupled to the inlet of the microphone via the outlet. Further, the inlet of the microphone is disposed in the cavity or in the outlet of the acoustic path. The acoustic path is devoid of a manifold associated with the microphone.

### Example Ex2

The device of Ex1, further including a shell configured to be disposed at least partially within an ear canal of a wearer. The shell includes an end surface that is configured to matingly engage a mating surface of the faceplate to form an enclosure of the electronic device.

### Example Ex3

The device of any one of Ex1-Ex2, where the acoustic path includes a cross-sectional area that decreases in a direction from the microphone port to the outlet of the acoustic path.

### Example Ex4

The device of any one of Ex1-Ex3, where the acoustic path is configured to direct acoustic waves incident on the microphone port to the inlet of the microphone.

### Example Ex5

The device of any one of Ex1-Ex4, where the acoustic path includes a straight portion adjacent to the microphone outlet and a curved or faceted portion adjacent to the outlet of the acoustic path.

### Example Ex6

The device of any one of Ex1-Ex5, where the acoustic path is defined by the faceplate.

### Example Ex7

The device of any one of Ex1-Ex5, where the acoustic path is inserted into an opening in the faceplate.

### Example Ex8

The device of any one of Ex1-Ex7, where the acoustic path further includes a trap disposed adjacent to the microphone port and disposed within the faceplate. The trap is configured to collect debris entering the acoustic path through the microphone port.

### Example Ex9

The device of any one of Ex1-Ex8, further including a basket disposed at least partially within the microphone port and configured to collect debris entering the acoustic path through microphone port.

### Example Ex10

The device of Ex9, where the basket includes at least one opening configured to transmit acoustic waves entering the acoustic path through the microphone port.

### Example Ex11

The device of any one of Ex1-Ex10, where the microphone is disposed completely within the cavity.

### Example Ex 12

The device of any one of Ex1-Ex11, further including a battery housing having a mounting interface configured to be connected to the inner surface of the faceplate and a battery compartment configured to receive a battery.

### Example Ex13

The device of Ex12, further including a flexible printed circuit board assembly (PCBA) supported by one or both of an exterior surface of the battery housing and the faceplate.

### Example Ex 14

The device of Ex13, where the microphone is electrically connected to the PCBA.

### Example Ex15

The device of any one of Ex1-Ex14, where the faceplate includes a nylon-based polyamide thermoplastic material.

### Example Ex16

An ear-wearable electronic device including a faceplate having an outer surface and an inner surface, where the faceplate defines a cavity disposed in the inner surface of the faceplate; a microphone disposed at least partially within the cavity and including an inlet; and an acoustic path disposed within the faceplate and extending between a microphone port disposed at the outer surface of the faceplate and an outlet disposed in the cavity. The acoustic path is acoustically coupled to the inlet of the microphone via the outlet. The inlet of the microphone is disposed in the cavity or in the outlet of the acoustic path. The acoustic path is configured such that all acoustic waves propagating within the acoustic path pass directly from the acoustic path to the inlet of the microphone.

### Example Ex17

The device of Ex16, further including a shell configured to be disposed at least partially within an ear canal of a wearer. The shell includes an end surface that is configured to matingly engage a mating surface of the faceplate to form an enclosure of the ear-wearable electronic device.

### Example Ex18

The device of any one of Ex16-Ex17, where the acoustic path includes a cross-sectional area that decreases in a direction from the microphone port to the outlet of the acoustic path.

### Example Ex19

The device of any one of Ex16-Ex 18, where at least a portion of the acoustic path includes an elliptical cross-section.

### Example Ex20

The device of any one of Ex16-Ex19, where the acoustic path comprises a straight portion adjacent to the microphone outlet and a curved or faceted portion adjacent to the outlet of the acoustic path.

### Example Ex21

The device of any one of Ex16-Ex20, where the acoustic path is defined by the faceplate.

### Example Ex22

The device of any one of Ex16-Ex20, wherein the acoustic path is inserted into an opening in the faceplate.

### Example Ex23

The device of any one of Ex16-Ex22, where the acoustic path further includes a trap disposed adjacent to the microphone port and disposed within the faceplate. The trap is configured to collect debris entering the acoustic path through the microphone port.

### Example Ex24

The device of any one of Ex16-Ex23, further including a basket disposed at least partially within the microphone port and configured to collect debris entering the acoustic path through microphone port.

### Example Ex25

The device of Ex24, where the basket includes at least one opening configured to transmit acoustic waves entering the acoustic path through the microphone port.

### Example Ex26

The device of any one of Ex16-Ex25, where the microphone is disposed completely within the cavity.

### Example Ex27

The device of any one of Ex16-Ex26, further including a battery housing including a mounting interface configured to be connected to the inner surface of the faceplate and a battery compartment configured to receive a battery.

### Example Ex28

The device of Ex27, further including a flexible printed circuit board assembly (PCBA) supported by one or both of an exterior surface of the battery housing and the faceplate.

### Example Ex29

The device of Ex28, where the microphone is electrically connected to the PCBA.

### Example Ex30

The device of any one of Ex16-Ex29, where the faceplate includes a nylon-based polyamide thermoplastic material.

### Example Ex31

A method of forming an ear-wearable electronic device including disposing a cavity in an inner surface of a faceplate; disposing a microphone at least partially within the cavity; and disposing an acoustic path at least partially within the faceplate. The acoustic path extends between a microphone port disposed at an outer surface of the faceplate and an outlet disposed in the cavity. Further, the acoustic path is acoustically coupled to the inlet of the microphone via the outlet. The inlet of the microphone is disposed in the cavity or in the outlet of the acoustic path. The method further includes directing acoustic waves through the microphone port and the acoustic path to the inlet of the microphone. The acoustic path is configured such that all acoustic waves propagating within the acoustic path pass directly from the acoustic path to the inlet of the microphone.

### Example Ex32

The method of Ex31, further including connecting an end surface of a shell to a mating surface of the faceplate to form an enclosure of the ear-wearable electronic device.

### Example Ex33

The method of any one of Ex31-Ex32, where disposing the cavity includes molding the faceplate such that the cavity is disposed in the inner surface of the faceplate.

### Example Ex34

The method of Ex31, where disposing the cavity includes etching the cavity in the inner surface of the faceplate.

### Example Ex35

The method of Ex31, where disposing the cavity includes 3D printing the faceplate such that the cavity is disposed in the inner surface of the faceplate.

### Example Ex36

The method of any one of Ex31-Ex35, where disposing the acoustic path includes molding the faceplate such that the acoustic path is disposed at least partially within the faceplate.

### Example 37

The method of any one of Ex31-Ex35, where disposing the acoustic path includes etching the acoustic path into the outer surface of the faceplate such that it extends from the microphone port at the outer surface of the faceplate to the outlet in the cavity.

### Example Ex38

The method of any one of Ex31-Ex35, where disposing the acoustic path includes 3D printing the faceplate such that the acoustic path is disposed at least partially within the faceplate.

### Example Ex39

The method of any one of Ex31-Ex38, further including electrically connecting the microphone to a flexible printed circuit board assembly (PCBA) that is disposed adjacent to the inner surface of the faceplate.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device comprising:
a faceplate comprising an outer surface and an inner surface, wherein the faceplate defines a cavity disposed in the inner surface of the faceplate;
a microphone disposed at least partially within the cavity and comprising an inlet; and
an acoustic path disposed at least partially within the faceplate and extending between a microphone port disposed at the outer surface of the faceplate and an outlet disposed in the cavity, wherein the acoustic path is acoustically coupled to the inlet of the microphone via the outlet, wherein the inlet of the microphone is disposed in the cavity or in the outlet of the acoustic path;
wherein the acoustic path is devoid of a manifold associated with the microphone.

2. The device of claim 1, further comprising a shell configured to be disposed at least partially within an ear canal of a wearer, the shell comprising an end surface that is configured to matingly engage a mating surface of the faceplate to form an enclosure of the electronic device.

3. The device of claim 1, wherein the acoustic path comprises a cross-sectional area that decreases in a direction from the microphone port to the outlet of the acoustic path.

4. The device of claim 1, wherein the acoustic path comprises a straight portion adjacent to the microphone outlet and a curved or faceted portion adjacent to the outlet of the acoustic path.

5. The device of claim 1, wherein the acoustic path is defined by the faceplate.

6. The device of claim 1, wherein the acoustic path further comprises a trap disposed adjacent to the microphone port and disposed within the faceplate, wherein the trap is configured to collect debris entering the acoustic path through the microphone port.

7. The device of claim 1, further comprising a basket disposed at least partially within the microphone port and configured to collect debris entering the acoustic path through microphone port.

8. The device of claim 1, further comprising a battery housing comprising a mounting interface configured to be connected to the inner surface of the faceplate and a battery compartment configured to receive a battery.

9. The device of claim 8, further comprising a flexible printed circuit board assembly (PCBA) supported by one or both of an exterior surface of the battery housing and the faceplate, wherein the microphone is electrically connected to the PCBA.

10. An ear-wearable electronic device comprising:
a faceplate comprising an outer surface and an inner surface, wherein the faceplate defines a cavity disposed in the inner surface of the faceplate;
a microphone disposed at least partially within the cavity and comprising an inlet; and
an acoustic path disposed within the faceplate and extending between a microphone port disposed at the outer surface of the faceplate and an outlet disposed in the cavity, wherein the acoustic path is acoustically coupled to the inlet of the microphone via the outlet, wherein the inlet of the microphone is disposed in the cavity or in the outlet of the acoustic path;
wherein the acoustic path is configured such that all acoustic waves propagating within the acoustic path pass directly from the acoustic path to the inlet of the microphone.

11. The device of claim 10, further comprising a shell configured to be disposed at least partially within an ear canal of a wearer, the shell comprising an end surface that is configured to matingly engage a mating surface of the faceplate to form an enclosure of the ear-wearable electronic device.

12. The device of claim 10, wherein the acoustic path comprises a cross-sectional area that decreases in a direction from the microphone port to the outlet of the acoustic path.

13. The device of claim 10, wherein the acoustic path comprises a straight portion adjacent to the microphone outlet and a curved or faceted portion adjacent to the outlet of the acoustic path.

14. The device of claim 10, wherein the acoustic path is defined by the faceplate.

15. The device of claim 10, wherein the acoustic path further comprises a trap disposed adjacent to the microphone port and disposed within the faceplate, wherein the trap is configured to collect debris entering the acoustic path through the microphone port.

16. The device of claim 10, further comprising a battery housing comprising a mounting interface configured to be connected to the inner surface of the faceplate and a battery compartment configured to receive a battery.

17. The device of claim 10, further comprising a flexible printed circuit board assembly (PCBA) supported by one or both of an exterior surface of the battery housing and the faceplate, wherein the microphone is electrically connected to the PCBA.

18. A method of forming an ear-wearable electronic device comprising:
disposing a cavity in an inner surface of a faceplate;
disposing a microphone at least partially within the cavity;
disposing an acoustic path at least partially within the faceplate, wherein the acoustic path extends between a microphone port disposed at an outer surface of the faceplate and an outlet disposed in the cavity, wherein the acoustic path is acoustically coupled to an inlet of the microphone via the outlet, wherein the inlet of the microphone is disposed in the cavity or in the outlet of the acoustic path; and
directing acoustic waves through the microphone port and the acoustic path to the inlet of the microphone, wherein the acoustic path is configured such that all acoustic waves propagating within the acoustic path pass directly from the acoustic path to the inlet of the microphone.

19. The method of claim 18, further comprising connecting an end surface of a shell to a mating surface of the faceplate to form an enclosure of the ear-wearable electronic device.

20. The method of claim 18, wherein disposing the acoustic path comprises molding the faceplate such that the acoustic path is disposed at least partially within the faceplate.
